(19) United States
(12) Patent Application Publication
(10) Pub. No.: US 2016/0342184 A1
(43) Pub. Date: Nov. 24, 2016

(54) MACHINE TOOL

(71) Applicant: FANUC Corporation, Yamanashi (JP)

(72) Inventor: Hideo KOBAYASHI, Yamanashi (JP)

(21) Appl. No.: 15/157,348

(22) Filed: May 17, 2016

(30) Foreign Application Priority Data
May 18, 2015 (JP) 2015-100669

(51) Int. Cl. G06F 1/28; G06F 13/42; G06F 9/44

(52) U.S. Cl. CPC G06F 1/28; G06F 9/442; G06F 13/4282

(57) ABSTRACT

A machine tool includes a numerical control unit, a personal computer unit, and a power source unit. Furthermore, the machine tool includes a shutdown unit which is connected with the personal computer unit through a power-off notification general-purpose interface and a power-disconnection monitoring general-purpose interface. The shutdown unit includes a personal computer power-off notification unit for notifying the personal computer unit of a power-off through the power-off notification general-purpose interface when a power-off signal is input, a determination unit for monitoring a voltage level of the power-disconnection monitoring general-purpose interface to determine whether the power source of the personal computer unit is disconnected, and a power source unit off-signal output unit for outputting a power-off signal to the power source unit when the determination unit determines disconnection of the power source of the personal computer unit.

### BACKGROUND OF THE INVENTION

1. Field of the Invention

The present invention relates particularly to a machine tool which includes a shutdown unit of a personal computer.

2. Description of the Related Art

When a power source of a personal computer is disconnected without terminating a running application or OS, a next operation of the personal computer is not guaranteed. If the worst happens, there is a possibility that a file system is broken not to be recognized by a BIOS or the OS and thus the personal computer is not booted up.

For this reason, when the personal computer is provided inside the machine tool and the power source of the entire apparatus is turned off, an uninterruptible power source (UPS) is suggested to be used. For example, in JP 2000-155607 A, an NC machine tool is disclosed in which an operation of the personal computer unit is continued with a power supplied from a reserve power source (UPS) when a power failure occurs so that a shutdown process is performed.

FIG. 4 is a diagram illustrating the related art disclosed in JP 2000-155607 A. A machine tool 1 disclosed in JP 2000-155607 A includes a numerical control unit 10, a personal computer unit 11, a power source unit 12, and an uninterruptible power source (UPS) 15 inside the machine tool 1. In the machine tool 1, when an off switch 2 is pressed, a power-off signal is input to the power source unit 12 so as to disconnect the power source. The uninterruptible power source 15 detects disconnection of the power source and starts a power supply from a built-in battery to the personal computer unit 11. The power supply is continued until the personal computer unit 11 is shut down. The personal computer unit 11 starts the shutdown process on the basis of a power-off notification from the uninterruptible power source 15, and when the shutdown process is completed, the uninterruptible power source 15 determines that the personal computer unit 11 completes the shutdown process and disconnects the power source of the personal computer unit 11.

On the other hand, as a technology in which a power source of an apparatus having a personal computer provided inside a machine tool is securely turned off without using an UPS, for example, JP 2003-122457 A discloses a system which detects that a completion signal of a shutdown process is output from the personal computer and disconnects the power source of the apparatus, when an operation of the apparatus is terminated.

In addition, JP 06-119087 A discloses the configuration in which a shutdown circuit is provided between a power source unit and a personal computer and the power source is turned off in a software manner by a shutdown program.

FIG. 5 is a diagram illustrating the related art disclosed in JP 2003-122457 A. A machine tool 1 disclosed in JP 2003-122457 A includes a numerical control unit 10, a personal computer unit 11, and a power source unit 12 inside the machine tool 1. In the machine tool 1, when an off switch 2 is operated so that a power-off signal is input to the personal computer unit 11, the personal computer unit 11 starts a shutdown process. Thereafter, when the shutdown process of the personal computer unit 11 is completed, the personal computer unit 11 notifies the power source unit 12 of a shutdown completion signal. Then, the power source unit 12 disconnects a DC power source of the personal computer unit 11.

However, in order to introduce the technology disclosed in JP 2000-155607 A, for example, a space for providing the UPS is required inside the machine tool. In addition, the maintenance of the UPS is required, which results in an increase in overall cost.

In addition, in the method of disconnecting the power source of the personal computer without using the UPS as disclosed in JP 2003-122457 A, the shutdown signal is necessary to output to the outside of the personal computer and thus there is a limitation on a personal computer to be embedded. Furthermore, even in the technology disclosed in JP 06-119087 A, in order to control the power source for the personal computer, a dedicated circuit which turns on/off the DC power source is required. In addition, it is necessary to provide a dedicated interface for the circuit in the personal computer or to embed a dedicated process for the shutdown process.

### SUMMARY OF THE INVENTION

In this regard, an object of the invention is to provide a machine tool which disconnects a power source after completion of a shutdown process of a personal computer when the power source of the machine tool with the built-in personal computer is disconnected.

The machine tool according to the invention, which includes a control unit having a numerical control unit and a personal computer unit and a power source unit supplying a power to the numerical control unit and the personal computer unit, includes a shutdown unit. The shutdown unit is connected with the personal computer unit through a power-off notification general-purpose interface and a power-disconnection monitoring general-purpose interface, and the shutdown unit includes a personal computer power-off notification unit for notifying the personal computer unit of a power-off through the power-off notification general-purpose interface when an off signal to turn off the power source of the control unit is input, a determination unit for monitoring a voltage level of the power-disconnection monitoring general-purpose interface to determine whether the power source of the personal computer unit is disconnected, and a power source unit off-signal output unit for outputting a power-off signal to the power source unit when the determination unit determines disconnection of the power source of the personal computer unit.

The power-off notification general-purpose interface may be a USB. In addition, the power-disconnection monitoring general-purpose interface may be a USB. The same general-purpose interface may be used as the power-off notification general-purpose interface and the power-disconnection monitoring general-purpose interface.

According to the invention, the power source of the personal computer can be securely disconnected without providing a huge apparatus such as an UPS inside the machine tool and embedding a dedicated interface for outputting a signal to the personal computer.

### BRIEF DESCRIPTION OF THE DRAWINGS

The above object, other objects, and features of the invention will become clear through the description of the following embodiments with reference to the accompanying drawings as follows:

FIG. 1 is a block diagram illustrating a main portion of a machine tool according to an embodiment of the invention;

FIG. 2 is a diagram schematically illustrating a configuration of a shutdown unit according to the embodiment of the invention;

FIG. 3 is a flowchart schematically illustrating processes executed on the machine tool according to an embodiment of the invention;

FIG. 4 is a block diagram (1) illustrating a main portion of a machine tool in the related art; and

FIG. 5 is a block diagram (2) illustrating a main portion of a machine tool in the related art.

### DETAILED DESCRIPTION OF THE PREFERRED EMBODIMENTS

Hereinafter, an embodiment of the invention will be described with reference to the drawings. Further, the configuration which is the same as or similar to the description of the related art will be described using the same reference numerals.

In the invention, a shutdown unit is used which can be connected through a general-purpose interface included in a personal computer. A power-off signal is delayed by the shutdown unit until the personal computer completes a shutdown process, and then a power source of a power source unit is disconnected. Thus, the power source of the personal computer can be securely disconnected without using an UPS.

The shutdown unit notifies the personal computer of the power-off using, for example, a USB as a general interface. In addition, the shutdown unit checks completion of the shutdown process by checking the power source of a USB port of the personal computer and a voltage level of a signal. By such a configuration, a dedicated hardware is not required in addition to the shutdown unit connected through the general-purpose interface. In addition, since the signal inside the personal computer is not necessary to output to the outside, the general-purpose personal computer can be used. Furthermore, since the control is to delay the power-off signal, it is not necessary to separately provide a circuit which turns on/off DC the power source.

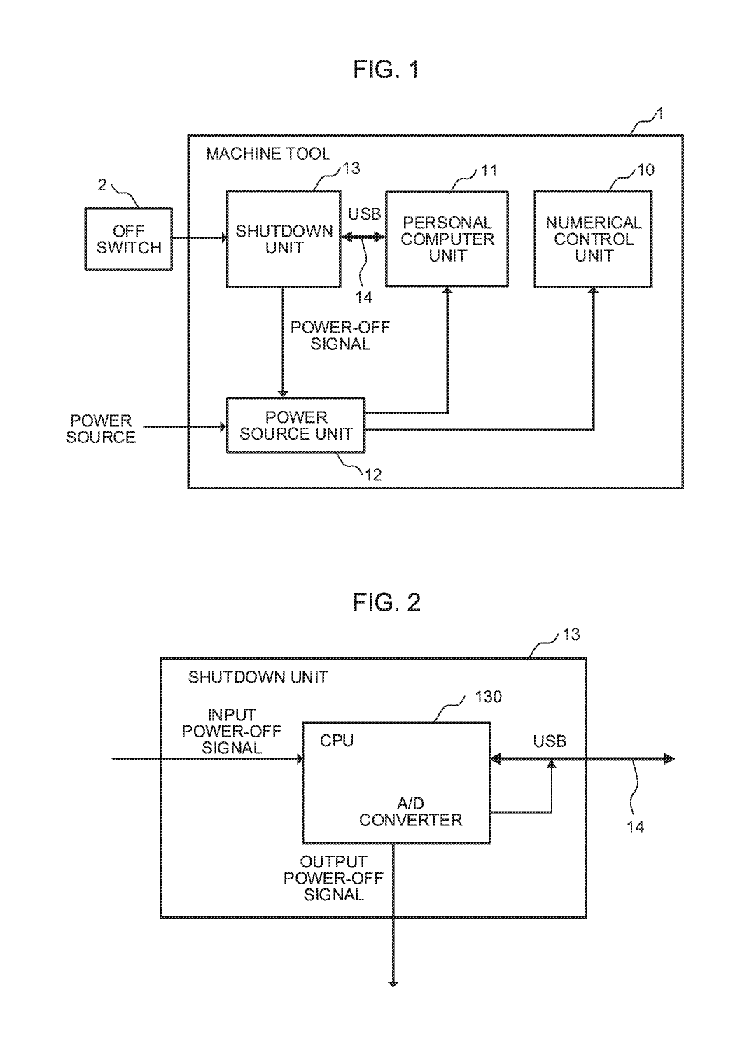

FIG. 1 is a block diagram illustrating a main portion of a machine tool according to the embodiment of the invention. A machine tool 1 includes a numerical control unit 10, a personal computer unit 11, a power source unit 12, and a shutdown unit 13 therein. Further, in the present embodiment, the example is described in which the same USB is used as a general-purpose interface for notifying the personal computer unit 11 of the power-off signal and a general-purpose interface used for monitoring whether the power source of the personal computer unit is disconnected.

In the machine tool 1 of the embodiment, when an operator presses an off switch 2, the power-off signal is input to the shutdown unit 13. The shutdown unit 13 notifies the personal computer unit 11 of a power-off command through a USB 14.

In the personal computer unit 11, a driver software for processing the power-off command notified through the USB 14 is installed, and when the power-off command is received from the shutdown unit 13 by the driver software, the personal computer unit 11 starts the shutdown process. Further, the driver software is well-known by a driver software for an uninterruptible power source and the like, and thus the detailed description is not repeated.

Thereafter, when the shutdown process of the personal computer unit 11 is completed and the power source of the personal computer unit 11 is disconnected, the power supply is not performed from the personal computer unit 11 to the USB 14.

The shutdown unit 13 monitors a power source (V_{BUS}) of the USB 14 or a voltage level of a signal (D+, D−) and determines whether the power source of the personal computer unit 11 is disconnected, and if the power source of the personal computer unit 11 is disconnected, the shutdown unit outputs a power-off signal to the power source unit 12 so as to disconnect the power source.

FIG. 2 is a diagram schematically illustrating a configuration of the shutdown unit 13 according to the embodiment. The shutdown unit 13 includes, for example, a CPU 130 implementing the following functions.
Function 1: a USB device controller for the connection with a personal computer
Function 2: an A/D converter for checking a power source of the USB device controller and a voltage level of a signal
Function 3: an input interface for inputting a power-off signal
Function 4: an output interface for outputting the power-off signal

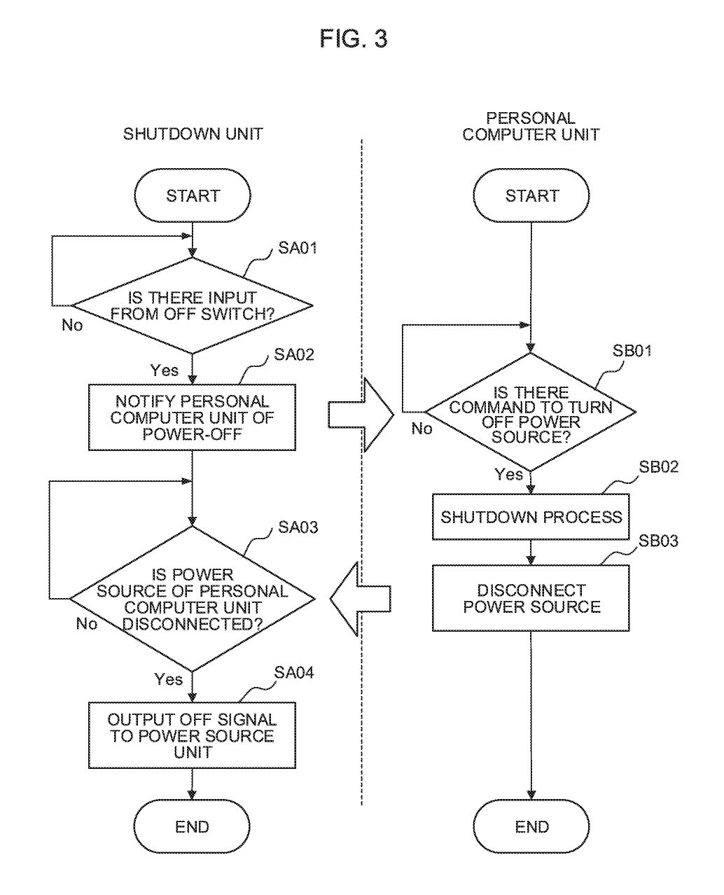

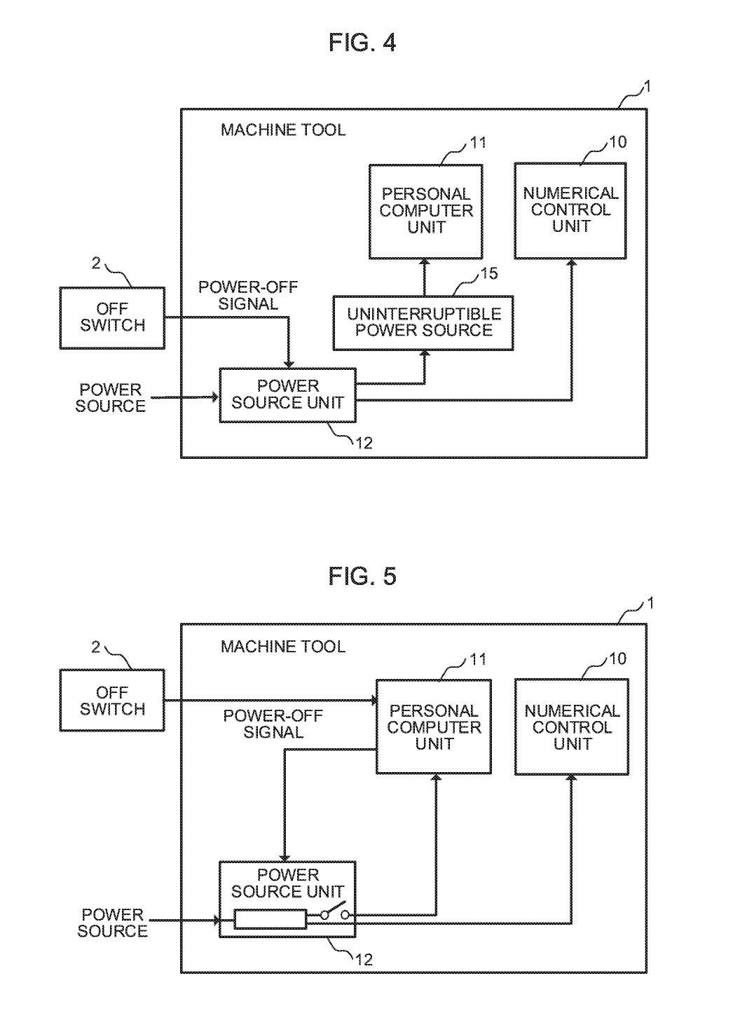

FIG. 3 is a flowchart illustrating an algorithm of processes executed on the machine tool of the embodiment. Hereinafter, the description will be given according to each step. Steps SA01 to SA04 represent processes performed in the shutdown unit 13 and steps SB01 to SB03 represent processes performed in the personal computer unit 11.

First, the processes executed in the shutdown unit 13 will be described.
[Step SA01] The shutdown unit 13 regularly monitors whether the power-off signal is input from the off switch 2. When the power-off signal is input, the procedure proceeds to step SA02, and when the power-off signal is not input, the monitoring is repeated.
[Step SA02] When the power-off signal is input from the off switch 2, the shutdown unit 13 commands, through the USB 14, the personal computer unit 11 to turn off the power source.
[Step SA03] The shutdown unit 13 monitors the power source of the USB 14 and the voltage level of the signal and determines whether the power source of the personal computer unit 11 is disconnected. When it is determined that the power source is disconnected, the procedure proceeds to step SA04, and when the power source is not disconnected, the power source of the USB 14 and the voltage level of the signal are continuously monitored.
[Step SA04] When it is determined that the power source of the personal computer unit 11 is disconnected, the shutdown unit 13 outputs the power-off signal to the power source unit 12.

Next, the processes executed in the personal computer unit 11 will be described.
[Step SB01] The personal computer unit 11 sends a command to the shutdown unit 13 through the USB 14 and monitors whether there is a command to turn off the power source. When there is the command to turn off the power source, the procedure proceeds to step SB02, and when there is not the command, the monitoring is continued.
[Step SB02] When the command to turn off the power source is checked from the shutdown unit 13, the personal computer unit 11 starts the shutdown process.
[Step SB03] When the shutdown process is completed, the personal computer unit 11 disconnects the power source of the personal computer. Simultaneously, the power source supplied from the personal computer unit 11 to the USB 14 is also disconnected.

Hereinbefore, the embodiment of the invention is described, but the invention is not limited to the above-described embodiment and can be implemented in various modes by modifying the above-described embodiment properly.

For example, in the above-described embodiment, the example is described in which the USB is used as the general-purpose interface used when the shutdown unit 13 commands the personal computer unit 11 to turn off the power source and the general-purpose interface used when the shutdown unit 13 monitors whether the power source of the personal computer unit 11 is disconnected. However, as the general-purpose interface for commanding the power-off, RS-232C, a wired LAN, or the like may be also used among interfaces included in a general personal computer. In addition, as the general-purpose interface for monitoring whether the power source is disconnected, an interface, in which the power is not supplied when the power source of the personal computer unit 11 is disconnected, may be used among the interfaces included in the general personal computer. The invention can be implemented by using any one of the interfaces.

In addition, in such a case, different general-purpose interfaces may be used as the general-purpose interface for commanding the power-off and the general-purpose interface for monitoring whether the power source is disconnected.

Hereinbefore, the embodiment of the invention is described, but the invention is not limited to the above-described embodiment and can be implemented in another mode by modifying the above-described embodiment properly.

1. A machine tool including a control unit having a numerical control unit and a personal computer unit and a power source unit supplying a power to the numerical control unit and the personal computer unit, the machine tool comprising:
a shutdown unit,
wherein the shutdown unit is connected with the personal computer unit through a power-off notification general-purpose interface and a power-disconnection monitoring general-purpose interface, and
wherein the shutdown unit includes
a personal computer power-off notification unit for notifying the personal computer unit of a power-off through the power-off notification general-purpose interface when an off signal to turn off the power source of the control unit is input,
a determination unit for monitoring a voltage level of the power-disconnection monitoring general-purpose interface to determine whether the power source of the personal computer unit is disconnected, and
a power source unit off-signal output unit for outputting a power-off signal to the power source unit when the determination unit determines disconnection of the power source of the personal computer unit.

2. The machine tool according to claim 1,
wherein the power-off notification general-purpose interface is a USB.

3. The machine tool according to claim 1,
wherein the power-disconnection monitoring general-purpose interface is a USB.

4. The machine tool according to claim 1,
wherein the same general-purpose interface is used as the power-off notification general-purpose interface and the power-disconnection monitoring general-purpose interface.
